(19) United States
(12) Patent Application Publication
(10) Pub. No.: US 2009/0120460 A1
(43) Pub. Date: May 14, 2009

(54) SOFT FLOOR PRE-SPRAY UNIT UTILIZING ELECTROCHEMICALLY-ACTIVATED WATER AND METHOD OF CLEANING SOFT FLOORS

(75) Inventors: Frederick A. Hekman, Holland, MI (US); Bruce F. Field, Golden Valley, MN (US); Peter A. Swenson, Minneapolis, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Tennant Company, Minneapolis, MN (US)

(21) Appl. No.: 12/268,034

(22) Filed: Nov. 10, 2008

Related U.S. Application Data
(60) Provisional application No. 60/986,661, filed on Nov. 9, 2007.

(51) Int. Cl. B08B 3/08; B08B 1/00

(52) U.S. Cl. 134/6; 134/36; 134/18; 134/21; 134/10

(57) ABSTRACT

A method is provided, which includes applying electrochemically activated acid and alkaline water to a surface as a pre-spray, allowing the electrochemically activated acid and alkaline water to remain on the surface for a dwell time, and after the dwell time, performing a cleaning operation on an area of the surface to which the pre-spray was applied.

### CROSS-REFERENCE TO RELATED APPLICATIONS

The present application is based on and claims the benefit of U.S. Provisional Patent Application No. 60/986,6611, filed Nov. 9, 2007, the content of which is hereby incorporated by reference in its entirety.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to methods and apparatus for cleaning soft surfaces such as soft floors (e.g., carpet).

### BACKGROUND OF THE DISCLOSURE

Carpet offers many benefits as a floor covering but it is challenging to clean. Carpet acts as a filter and traps airborne and traffic-produced soil both on the surface of the carpet fibers as well as down in the base of the pile. Carpet has a very high effective surface area per square foot and tremendous dirt-holding potential. When carpet cleaning processes are compared to hard floor scrubbing processes, the carpet cleaning processes are slower, more complicated, and not as effective at removing all of the soil from the surface. Even so, there is a great need for carpet cleaning.

There is a variety of equipment available from companies, such as Tennant Company of Minneapolis, Minn., U.S.A., for vacuuming, sweeping, and wet-cleaning carpet. For example, Tennant's wet-cleaning carpet equipment typically falls into two categories:

### 1. Hot Water Extraction Equipment.

This equipment sprays water on the carpet, agitates the wetted carpet with a floor tool or brush, and recovers the dirty water from the carpet using a vacuumized floor tool. Examples from the Tennant product line include simple canister extractors, such as the Tennant model 1000; canister units with heat, such as the Tennant model 1180, self-contained extractors, such as the Tennant model 1240; and automatic (self-propelled) extractors, such as the Tennant model 1510.

### 2. Soil Transfer Extraction Equipment.

This type of equipment uses one or more soil transfer rollers for carpet cleaning. The rollers are wetted, rubbed against the carpet to pick up soil from the carpet and extracted. This soil is continuously removed by wetting and extraction of the roller, but no water is ever sprayed on the carpet. Examples from the Tennant product line include Tennant the model 1610 in ReadySpace™ mode and the Tennant model R14 Rider™ in ReadySpace™ mode.

Both types of carpet cleaning processes use water as the primary soil solvent and both processes are more effective if a cleaning chemical (e.g. a detergent or surfactant) is used in addition to water. Adding a small amount of such a chemical to the cleaning process typically gives better wetting of the carpet, allows dissolution of oil-based soil, and increases overall soil removal. If the cleaning chemicals are mixed with the water in the clean-water tank it will give a limited amount of cleaning improvement, but for maximum benefit the chemical should somehow be applied to the carpet and allowed to work for 10-15 minutes before the final extraction or mechanical cleaning process is performed. So if the chemical is mixed in the tank and dispensed by the machine, it may require a second pass (after some dwell time) to get maximum cleaning effect.

Another way to give the chemical adequate dwell time is to apply a water/chemical mixture as a spray without any agitation or vacuum recovery. This is called pre-spraying and often a pump-up 2-gallon sprayer is used for this purpose. The sprayer includes a water reservoir, a means to pressurize it, and a spray nozzle attached to a wand with a valve to allow the user to apply the spray wherever desired. Small areas are progressively pre-sprayed and then extracted 10-15 minutes later. With this approach, when the extraction is performed the process rinses the carpet and removes both soil and chemical from the carpet.

Whether the chemicals are used in-the-tank or as a pre-spray, some amount of the chemical will always be left behind. Typical extraction processes recover 50% of the water applied to the carpet, so about 50% of the water is left behind. The water will evaporate over time, but most of the cleaning chemical will not. Thus an extraction process using an in-tank chemical will result in about 50% of the chemical being left behind in the carpet. If a pre-spraying approach is used, the amount of chemical left behind depends on how much was applied and how thoroughly it was rinsed. If the chemical is pre-sprayed lightly and rinsed repeatedly the amount of chemical left behind can be progressively reduced, but multiple rinsing steps usually lead to a very wet carpet and an excessively long dry time. It is difficult to predict exactly how much chemical will be left behind, but it is safe to say that even with appropriate rinsing a significant amount of chemical will remain in the carpet.

Any amount of cleaning chemical residue is a concern because most of the detergent chemicals involved by their very nature act to attract and bind to soil. If they remain in the carpet and continue to attract and bind to soil they can actually make the carpet get dirty faster. This phenomenon is known as “resoiling” and it needs to be considered when selecting a carpet cleaning chemical. In addition to the resoiling issue, carpet cleaning chemicals pose potential health risks and often have negative environmental impacts during use and disposal.

### SUMMARY

An aspect of the disclosure is directed to a method, which includes applying electrochemically activated acid and alkaline water to a surface as a pre-spray, allowing the electrochemically activated acid and alkaline water to remain on the surface for a dwell time, and after the dwell time, performing a cleaning operation on an area of the surface to which the pre-spray was applied.

In one example, the dwell time is at least one minute. In another example, the dwell time is at least five minutes. In another example, the dwell time is in a range of one minute to one-half an hour.

In a non-limiting aspect of the disclosure, the surface includes any soft floor surface, such as carpet.

In an aspect of the disclosure:
the step of applying is performed by a pre-spray device; and
the cleaning operation is performed by a cleaning device that is disconnected from the pre-spray device and separately movable relative to the surface.

In a further aspect of the disclosure the step of applying is performed by a pre-spray device that is a member of the group including:
a hand-held spray bottle comprising an electrolysis cell,
a humanly portable, non-wheeled canister comprising an electrolysis cell and a spray wand;
a wheeled device carrying an electrolysis cell and a ECA water dispenser.

In a further aspect of the disclosure the step of applying includes generating the electrochemically activated acid and alkaline water with an electrolysis cell carried by a pre-spray device, blending the electrochemically activated acid and alkaline water within the pre-spray device and applying the blended electrochemically activated acid and alkaline water to the surface as the pre-spray with the pre-spray device.

In a further aspect of the disclosure, the step of performing a cleaning operation is performed by a cleaning device that is a member of the group including:

a hot water extractor; and

a soil transfer device comprising a soil transfer roller.

In a further aspect of the disclosure, the step of applying is performed in a first pass over the surface with a wheeled device and the step of performing a cleaning operation is performed in a second, subsequent pass over the surface with the same wheeled device.

In a further aspect of the disclosure, the step of performing a cleaning operation comprises applying further electrochemically activated water to the surface with a wheeled, mobile cleaning device and then recovering, with the mobile cleaning device, at least portions of the electrochemically activated water that was applied as the pre-spray and at least portions of the further electrochemically activated water applied by the mobile cleaning device.

Another aspect of the disclosure is directed to a method, which includes: applying electrochemically activated acid and alkaline water to carpet as a combined pre-spray with a pre-spray device; allowing the electrochemically activated water to remain on the carpet for a dwell time; and after the dwell time, recovering the electrochemically activated water from the carpet during a cleaning operation performed with a cleaning device, which is unconnected to the pre-spray device and separately movable relative to the carpet.

In one example of this further aspect of the disclosure, the dwell time is at least one minute. In another example, the dwell time is at least five minutes. In another example, the dwell time is in a range of one minute to one-half an hour.

In an example of this further aspect of the disclosure, the pre-spray device is a member of the group including:
a hand-held spray bottle comprising an electrolysis cell,
a humanly portable, non-wheeled canister comprising an electrolysis cell and a spray wand;
a wheeled device carrying an electrolysis cell and a ECA water dispenser.

In another example of this further aspect, the step of applying includes generating the electrochemically activated acid and alkaline water with an electrolysis cell carried by the pre-spray device, blending the electrochemically activated acid and alkaline water within the pre-spray device and applying the blended electrochemically activated acid and alkaline water to the surface as the combined pre-spray with the pre-spray device.

In another example of this further aspect, the step of applying includes generating the electrochemically activated acid and alkaline water with an electrolysis cell carried by the pre-spray device, combining separate flows of the acid and alkaline water into a combined flow applying the combined flow to the surface through a spray nozzle.

In another example of this further aspect, the cleaning device is a member of the group including:
a hot water extractor; and
a soil transfer device comprising a soil transfer roller.

In yet another example of this further aspect:
the cleaning device comprises a wheeled mobile cleaning device;
the step of performing a cleaning operation comprises applying further electrochemically activated water to the surface with the wheeled mobile cleaning device; and
the method includes recovering, with the wheeled mobile cleaning device, at least portions of the electrochemically activated water that was applied as the pre-spray and at least portions of the further electrochemically activated water applied by the wheeled mobile cleaning device.

### BRIEF DESCRIPTION OF THE DRAWINGS

FIG. 1 is a chart illustrating test results according to an example pre-spray process according to an aspect of the disclosure as compared to other processes of the prior art.

FIG. 2 illustrates a schematic representation of a pre-spray device according to an example of the disclosure.

FIG. 3 illustrates an example of a pre-spray device according to another example of the disclosure.

FIG. 4 illustrates a pre-spray device, which is configured as a canister for being carried by the user, such as by hand, over the user's shoulder or back.

FIG. 5 is a flow chart illustrating a method of cleaning a soft surface, such as carpet according to an example of the present disclosure.

FIG. 6 is a schematic diagram illustrating an example of an electrolysis cell that can be used in the pre-spray and cleaning devices disclosed herein, for example.

FIG. 7 illustrates an example of an electrolysis cell having a tubular shape according to one illustrative example.

### DETAILED DESCRIPTION OF ILLUSTRATIVE EMBODIMENTS

This disclosure relates primarily to soft floor, such as carpet cleaning methods and equipment. However, the disclosure can be applied to pre-spraying other types of floor and non-floor surfaces, both hard and soft.

U.S. Publ. No. 2007/0186368A1, published Aug. 16, 2007, which is incorporated herein in its entirety, discloses methods and apparatus for cleaning floor and other surfaces with electrochemically activated water.

The application of Electro-Chemically Activated water (“ECA water”) for cleaning carpet is attractive for several reasons. Using en electrolysis cell, separate streams of high-pH (“Alkaline water”) and low-pH (“Acid water”) can be produced by the electrolysis cell, and these streams can either be used separately or they can be combined and used as a mixed product. As described in the above-mentioned publication, mixed ECA water has temporal cleaning properties and can clean with properties similar to a water/surfactant mixture if it is applied to the surface quickly. It has been shown that ECA water can clean better than water alone. It does not require any additional chemicals and thus avoids the expense of chemicals and the health hazards of chemicals. Over a relatively short time, mixed ECA water self-neutralizes so that any residual cleaning fluid left behind will be indistinguishable from ordinary water. Thus resoiling issues, residual health concerns, and environmental issues from disposal are all eliminated. For all these reasons the use of ECA water in carpet cleaning is an attractive proposition.

The inventors of the present application have found that through testing on carpet that ECA water does in fact clean better than water alone. In one non-limiting example, it was been found that the optimum cleaning properties were achieved when the solution was applied as a pre-spray with dwell time rather than applied and extracted in a single step with a single machine.

### 1. Example Pre-Spray Devices

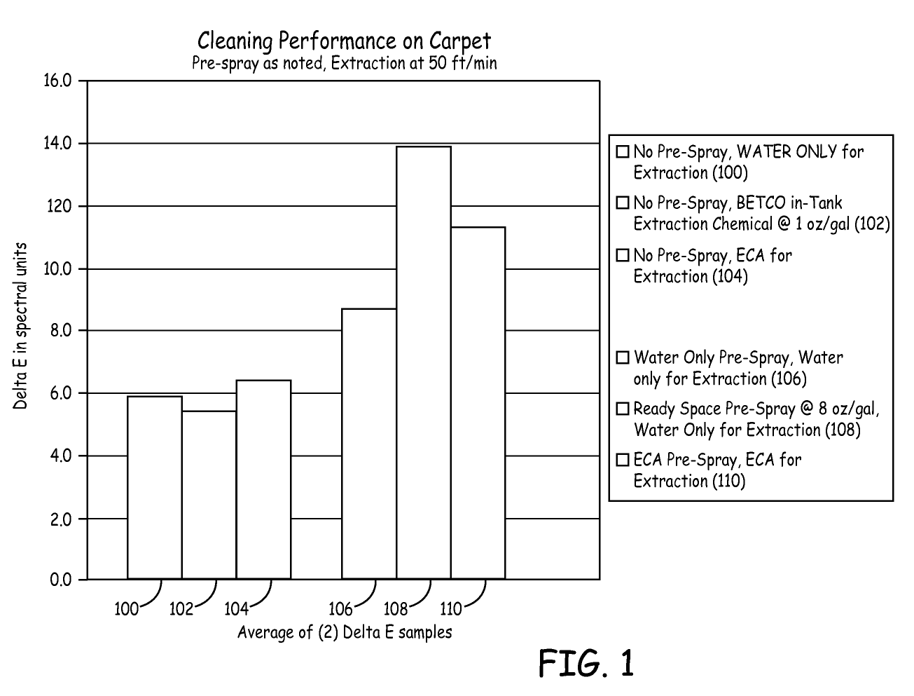

FIG. 1 is a chart illustrating test results according to the above-mentioned example. For the test, a Tennant model 1610 Soil Transfer Extraction carpet cleaner was used at an extraction rate of 50 feet per minute. The cleaner had a carper roller scrub head and a vacuum extraction device. The cleaner was modified to deliver either, water only, water combined with an in-tank detergent, or a mixed ECA water to the roller. The cleaning efficacy was tested with and without a pre-spray operation.

The Y-axis illustrates cleaning efficacy, Delta E, in spectral units. Each bar on the X-axis represents an average of two Delta E samples. Delta E represents the amount of dirt recovered from the carpet by the cleaner, as measured by reflection of light transmitted to a sample of the recovered water. The greater the value of Delta E, the better the cleaning efficacy.

Bar 100 represents the use of water only by the cleaner as the cleaning liquid, with no prior pre-spray operation. Bar 102 represents the use of water and a BETCO In-Tank Extraction Chemical at 1 oz/gal. by the cleaner as the cleaning liquid, with no prior pre-spray operation. Bar 104 represents the use of mixed ECA water (Alkaline and Acid) only by the cleaner as the cleaning liquid, with no prior pre-spray operation.

Bar 106 represents the use of water only as a pre-spray and then water only by the cleaner as the cleaning liquid. Bar 108 represents the use of a ReadySpace™ Pre-Spray @ 8 oz/gal. and then water only by the cleaner as the cleaning liquid. Bar 110 represents the use of a mixed ECA water (Alkaline and Acid) as a pre-spray and then a mixed ECA water by the cleaner as the cleaning liquid.

As shown in FIG. 1, mixed ECA water (Alkaline and Acid) used as a pre-spray (bar 110) achieved cleaning results somewhere between the use of water only and a conventional ReadySpace™ Pre-spray chemical. Additional testing with Alkaline ECA water and Acid ECA water has shown some promise for these products as well in specific applications.

In one example, to take full advantage of ECA water as a pre-spray, the solution is applied and allowed to dwell on the carpet for some time prior to extraction. Examples of suitable dwell times include at least 30 seconds, at least one minute, at least five minutes, at least ten minutes, a range of one minute to one-half an hour, and a range of ten minutes to fifteen minutes. Other ranges can also be used.

Although the same cleaning machine was used as the ECA pre-spray device and the Extractor for this testing, this arrangement is not ideal. The machine (a modified Tennant model 1610) is large, heavy and not very maneuverable. In addition, the amount of water dispensed is significantly higher than the ideal amount for this type of pre-spraying. For these reasons an alternate configuration is desired.

One aspect of the present disclosure relates to apparatus and methods for applying mixed ECA water as a pre-spray, wherein the apparatus is unconnected from the device that performs the cleaning operation (e.g., an extractor, soil transfer roller, etc.) and is separately movable relative to the carpet.

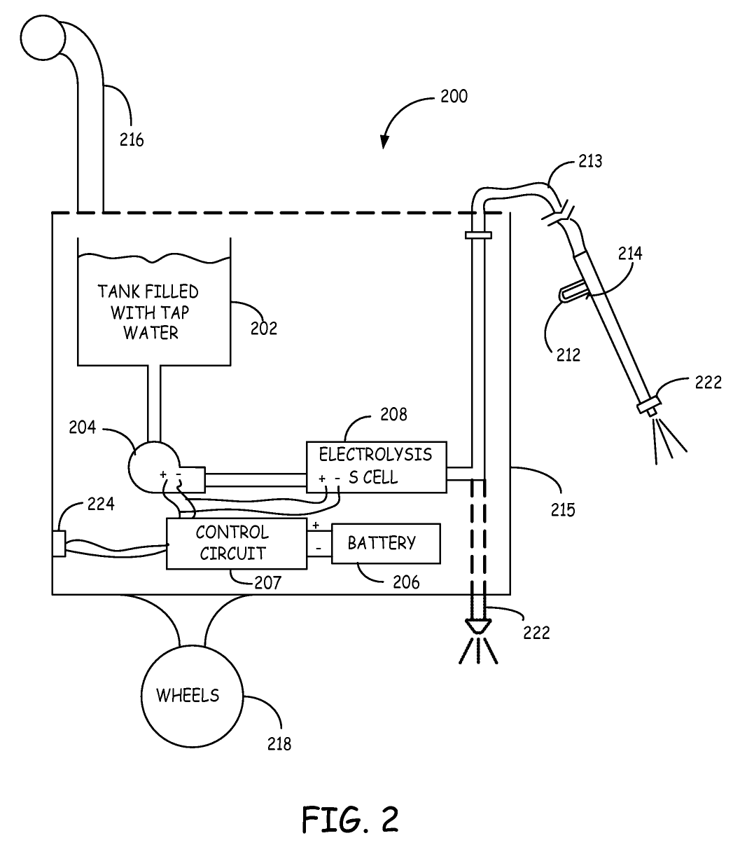

In one example, the ECA water pre-spray device is simpler and smaller than a walk-behind extractor. FIG. 2 illustrates a schematic representation of a pre-spray device 200 according to an example of the disclosure. Pre-spray device 200 includes a reservoir 12 (or tank) 202 for containing a liquid to be treated and then dispensed as a pre-spray. In an example, the liquid to be treated includes an aqueous composition, such as regular tap water. In an embodiment, the aqueous composition contains no more than 1.0 moles per liter salt. In another embodiment, the aqueous composition contains no more than 0.1 moles per liter salt. An aqueous composition containing more than 1.0 moles per liter salt can be used in further embodiments.

Reservoir 202 can be replaced with any other source of a cleaning liquid, such as a liquid input, spigot and/or valve for coupling to a hose or other source of water.

Device 200 further includes a pump 204 to draw water out of the liquid source (tank) 202 and pressurize it for effective spraying. Pump 202 can be eliminated in some examples. For example, a pump would not be needed when the liquid source itself is pressurized, such as through a hose. Pump 204 can be configured to operate by electricity, such as from battery 206 or manually by the operator, such as with a hand pump. For example, a hand pump can be used to pressurize the interior of tank 202.

Electrolysis cell 208 electrochemically activates the feed water provided by tank 202. Electrolysis cell 208 and/or pump 204 are controlled by a control circuit 206 and powered by battery 206.

A spray nozzle 210 is attached to a wand 212 of some sort for directing and applying the electrochemically-activated water onto the floor or other surface being cleaned. Wand 212 is attached to pre-spray device 200 through flexible tubing 213, for example. In one example, spray wand 212 includes a trigger or switch 214, which controls delivery of the ECA water to nozzle 210 through a valve. In a further example, trigger 214 electrically controls the operating mode of control circuit 207. When trigger 214 is actuated, control circuit 207 energizes pump 204 to pump water from tank 202 through electrolysis cell 208 to nozzle 210; and control circuit 207 energizes electrolysis cell 208 to electrochemically activate the water as it passes through the cell. When trigger 214 is deactuated, control circuit 207 de-energizes pump 204 and electrolysis cell 208. Trigger 214 can also close a valve, such as a solenoid valve in wand 212 to terminate residual water flow from nozzle 210. In a further example, control circuit 207 energizes and de-energizes pump 204 and electrolysis cell 208 separately from the operation of wand trigger 214. For example, device 200 can include an on/off switch and/or mode switches.

Pump 204 and/or electrolysis cell 208 can be located on a platform of device 200 (represented by dashed line 215) or on wand 212. Locating electrolysis cell 208 on wand 212 can reduce the length of the flow path from the cell to nozzle 210 and thus the time between ECA water generation and delivery of the activated water to the surface being cleaned. Pump 204 can be located upstream or downstream of cell 208.

In one example, the diameters of the tubes in device 200 and wand 212 are kept small so that once pump 204 and electrolysis cell 208 are energized, the tubing at the output of cell 208 and in wand 212 are quickly primed with electrochemically-activated liquid. Any non-activated liquid contained in the tubes and pump are kept to a small volume. Thus, in the embodiment in which the control circuit 207 activates the pump and electrolysis cell in response to actuation of trigger 214, pre-spray device 200 produces the mixed ECA water at nozzle 210 in an “on demand” fashion and dispenses substantially all of the combined anolyte and catholyte ECA liquid (except that retained in tubing 213) without an intermediate step of storing the acid and/or alkaline ECA water.

Other activation sequences can also be used. For example, control circuit 207 can be configured to energize electrolysis cell 208 for a period of time before energizing pump 204 in order to allow the feed water to become more electrochemically activated before dispensing.

The travel time from cell 208 to nozzle 210 can be made very short. In one example, pre-spray device 200 dispenses the blended acid and alkaline ECA water within a very small period of time from which the water is activated by electrolysis cell 208. For example, the mixed ECA water liquid can be dispensed within time periods such as within 5 seconds, within 3 seconds, and within 1 second of the time at which the water is activated.

Depending on the sprayer, nozzle 210 may or may not be adjustable, so as to select between squirting a stream, aerosolizing a mist, or dispensing a spray, for example.

In an alternative embodiment, pump 204 is replaced with a mechanical pump, such as a hand-triggered positive displacement pump implemented within wand 212, wherein the wand's trigger acts directly on the pump by mechanical action.

In a simple form, pre-spray device could be implemented in a platform only slightly larger and heavier than a 2-gallon pump-up type sprayer, for example, and could be hand-carried or configured as a backpack to be carried on the user's back, for example.

Enhancements that could be added to the simple form of the device in various combinations include, but are not limited to:
a handle 216 to make it easier to move about.
wheels 218 to avoid the need to lift and carry the weight of the unit (any suitable number of wheels can be used).
increased water capacity.
a quick-change rechargeable battery pack (e.g., an 18.8 or 24-volt battery pack from a power tool).
an on-board battery charger that could be plugged into an AC outlet.
an electrical plug for connecting to an external power source, such as through a power cord.
a fixed spray nozzle or nozzles 222 (such as those shown in FIGS. 12-15 of U.S. Patent Application Publ. No. 2007/0186368A1, in addition to the trigger-activated spray nozzle, to allow broadcast spraying of large areas by pulling (and/or pushing) the unit over the area to be pre-sprayed.
an On-Off Switch 224 for broadcast spray mode.
additional controls, valves and plumbing to allow use of the system to deliver either mixed ECA water, Acid ECA water, or Alkaline ECA water (such as shown and described with reference to FIG. 11 of U.S. Patent Application Publ. No. 2007/0186368A1).

If only one stream (e.g., alkaline ECA water) were being used the other stream could be collected in a separate reservoir for use or disposal later or it could be dumped back into the main water supply tank 202.

For delivering mixed ECA water through spray nozzle 210, the Acid ECA water and the Alkaline ECA water can be combined into blended flow at the output of electrolysis cell 208, at the output of spray nozzle 210 and/or at any point there between, for example. If the Acid ECA water and the Alkaline ECA water are combined at nozzle 310, device 200 can include a separate flow path for each water output from electrolysis cell 208 to nozzle 210. Accordingly, the pre-spray device can be configured in one or more embodiments to dispense acid ECA water and alkaline ECA water as a combined mixture or as separate spray outputs, such as through separate tubes and/or nozzles. In the embodiment shown in FIG. 1, the acid and alkaline ECA liquids are dispensed as a combined mixture.

In the example shown in FIG. 2, pre-spray device 200 lacks a recovery tool for recovering the sprayed ECA water from the surface being cleaned and lacks a cleaning tool or head, such as an extractor head or scrub head. In this embodiment, the unit is intended for use as a pre-spray device, not as a device for implementing the cleaning process. However, these elements could be added in alternative examples.

Although one exemplary application for this type of unit is envisioned as a pre-spray unit for carpet cleaning, almost any application where ECA water is desired for cleaning could benefit from the use of this unit to apply an ECA water solution prior to the application of a conventional cleaning process.

Additional applications such as upholstery, wall panels, or draperies could be addressed with little or no modification to the pre-spray unit. The unit could even be used in conjunction with (and/or incorporated on) an all-surface cleaner (e.g., Tennant model 750—such as that shown in FIG. 17 of U.S. Patent Application Publ. No. 2007/0186368A1) for restroom cleaning.

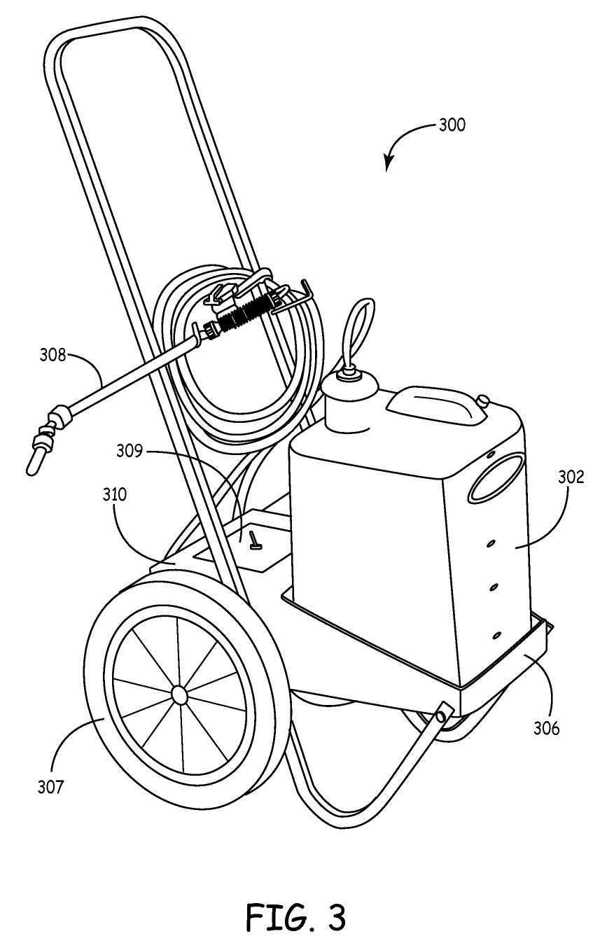

FIG. 3 illustrates an example of a pre-spray unit 300 according to an exemplary embodiment of the disclosure. This unit can be used to apply an ECA water pre-spray to the carpet instead of using a pump-up sprayer to apply a conventional chemical pre-spray. After a suitable dwell time, the actual carpet extraction would then be done with a conventional walk-behind (e.g., a Tennant model 1610), pull-back extractor (Tennant 1240) or rider (Tennant R-14), for example. These carpet extractors could also be modified to include similar ECA water activation equipment such as described in U.S. Patent Application Publ. No. 2007/0186368A1.

In one example, pre-spray unit 300 is built on a FIMCO model LG-5-P sprayer platform as shown in FIG. 3, which is available from FIMCO Industries of Dakota Dunes, S.Dak., U.S.A. The FIMCO platform includes:

a 5 gallon tank 302

10″ wheels 304 and a metal frame 306

a spray wand 308

a 12V DC pump 309

a 7 amp-hour 12V battery 310.

To this platform, the following elements can be added, for example:

a 2^{nd} 12V battery

a different spray tip—as modified to achieve a desired spray pattern and flow rate

an electrolysis cell and control circuit (as described in FIG. 2)

wiring to set up the 24V supply

pressure switches to interrupt power in a no-flow situation

The electrolysis cell can include a functional generator and related controller as shown and described with reference to FIGS. 1-6, 10-11, and 19-21 (for example) of U.S. Patent Application Publ. No. 2007/0186368A1. The unit can also be modified to include a sparging device as shown in the above-mentioned figures and also in FIG. 7, for example, in the above-mentioned publication.

For pre-spray unit 300, the electrolysis cell control circuit can be programmed, to implement the following requirements, for example:
1. Deliver maximum ECA effect with tap water. We will copy the parameters used for the Tennant model 1610 ECA-on-carpet units, except we will lower the maximum power level from 7.5 to 5.0 since we do not intend to use salt water (in one example). Therefore, program targets of 5 A to the electrolysis cell and 1.5 A to the sparger (if included), and expect to see actual values of 3+/−0.5 A to the cell and 1.5+/−0.5 to the sparger.
2. Reduce the Flip Time (alternate current polarity applied to the electrolysis cell) to 15 seconds (from earlier 150 sec) to reduce scaling.
3. Solenoid valve will be ON (open) at all times.
4. Pump will be run at a constant voltage (nominally 12V, maybe less if it is determined that this is more flow than necessary).
   Proposal: use the 3-position switch to provide different flow rates (e.g. “low”=8V, “med”=10V, “high”=12V to the pump). If needed, the different flow rates can be matched to different wand tips (e.g. 0.3, 0.5 and 0.7 GPM tips) to get a good pattern, but try a single 0.7 GPM tip at first.
5. DIP switches not used—ignore their settings.

The above parameters are provided as examples only and are likely to change for a particular application and design, particularly for production units.

Pre-spray unit 300 can be modified with the following electrical wiring, for example:
1. Connect the second battery in series, and run 24V (through the switch) to the electrolysis cell through +/−24V wires on an electrolysis cell wiring harness.
2. Provide two-charger-in-parallel connections to the battery and mount the second charger plug adjacent to the first one.
3. Mount the second charger fuse adjacent to the first one.
4. Power the pump (nominally a 12V pump) from the controller using the normal pump +/−wires in the electrolysis cell wiring harness.
5. Add two pressure switches to interrupt power to the cell and sparger (if included) when there is excess pressure (i.e. no flow). This pressure threshold can be determined and set through flow testing through the cell with the actual tip (e.g., 0.7 GMP) in the sprayer (e.g., normal flow=25 PSI, Shutoff=35 PSI, switch makes at 30 PSI).
6. Provide and label current sensing loops to allow manufacturer to easily measure pump, electrolysis cell and sparger currents. In one embodiment, these measurements can be implemented using a laptop computer connection, for example.
7. Wire-in a 24V battery meter and mount on the box lid if possible.

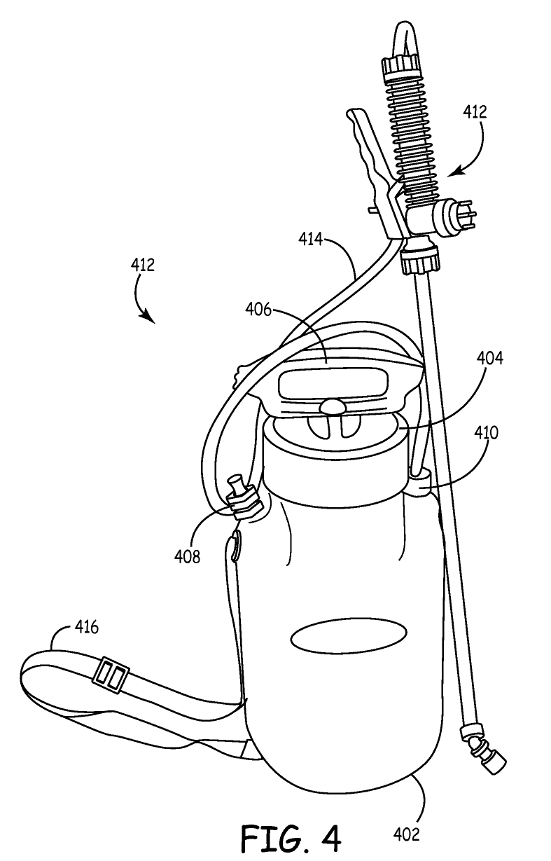

FIG. 4 illustrates a pre-spray device 400, which is configured as a canister for being carried by the user, such as by hand, over the user's shoulder or back. Device 400 includes a container 402 for containing a pre-spray liquid, such as regular tap water, a screw-on lid 404 with a handle 406 that operates a manual pump within container 402, a pressure release valve 408, an outlet 410, and a wand 412 connected to outlet 410 through one or more tubes 414. A strap 416 can be used to help carry device 400 over the user's shoulder, for example.

Pre-spray device 400 includes, for example, the battery 206, control circuit 207 and electrolysis cell 208 shown in FIG. 2, which can be incorporated into lid 406 and/or any other location internal or external to container 402. In an alternative example, the hand-operated pump actuated by handle 406 is replaced with an electrically-operated pump as shown in FIG. 2. Pre-spray device 400 can include all elements and configurations and can operate in a similar fashion as discussed with reference to FIG. 2 or any of the other examples described herein and/or described in U.S. Patent Application Publ. No. 2007/0186368A1.

### 2. Example Pre-spray and Cleaning Process

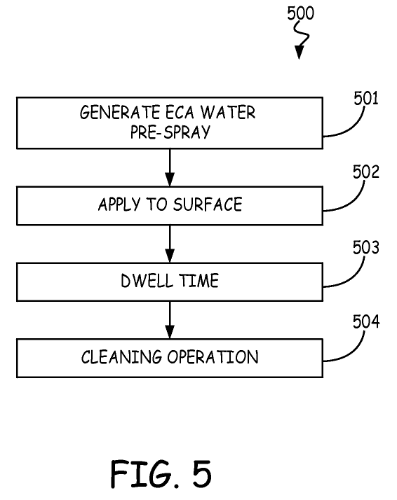

FIG. 5 is a flow chart illustrating a method 500 of cleaning a soft surface, such as carpet according to an example of the present disclosure. The method includes generating ECA water at step 501. The ECA water can be generated by a pre-spray device that is either separate from or incorporated within a soft floor (or other surface) cleaner device. For example, the pre-spray device can be unattached to, and movable relative to the floor separately from, the soft floor cleaner device. In another example, the pre-spray device can be attached to and/or otherwise movable with the soft floor cleaner device. The pre-spray device can be configured to be held by the user and/or carried by a movable or immovable platform.

The pre-spray device can be configured to generate and dispense a mixed acid and alkaline ECA water solution. In another example, the pre-spray device is configured to generate separate acid and alkaline ECA water outputs that are applied to the surface as separate streams and mixed on the surface and/or mixed at the output of the pre-spray device, for example.

At step 502, the ECA water (e.g., mixed acid and alkaline ECA water) is dispensed from the pre-spray device and applied to the surface to be cleaned. The ECA water can be applied directly to the surface from an output of the pre-spray device or through an intermediate container, for example. In one example, the ECA water is applied directly to the surface to minimize the time from ECA water generation to application to the surface. This maximizes the dwell time on the surface before the ECA water may neutralize.

The ECA water is applied to the surface in step 502 and allowed to dwell on the carpet at step 503 for some time prior to extraction. Examples of suitable dwell times include at least one minute, at least five minutes, at least ten minutes, a range of one minute to one-half an hour, and a range of ten minutes to fifteen minutes. Other ranges can also be used.

It has been found that although the ECA water may partially or fully self-neutralize during the dwell time, dirt particles lifted from the surface by the ECA water tend to stay in suspension within the pre-sprayed water and/or are more easily extracted by a subsequent cleaning process.

At step 504, after the dwell time, the cleaning operation is performed on the surface area to which the pre-spray was applied. This cleaning operation can be implemented by, for example, a cleaning head, such as a scrub head and/or an extraction tool, of a cleaning device. For example, a vacuumized extraction tool can be used to apply a cleaning liquid to the surface under high pressure and temperature and then recover at least a portion of the cleaning liquid and the ECA water pre-spray from the surface being cleaned. A scrub head can be used to mechanically work or agitate the surface during the cleaning operation. In one embodiment, the cleaning device applies additional ECA water to the surface. In another example, the cleaning device applies a chemical-based cleaning solution to the surface. The cleaning device can include, for example a hot water extractor or soil transfer extractor as described herein and/or described in U.S. Patent Application Publ. No. 2007/0186368A1.

In embodiments in which the pre-spray device is incorporated within the cleaning device, the pre-spray step 502 would be performed during a first pass or set of passes over the surface by the device. The cleaning step 504 would be performed during one or more second, subsequent passes over the surface by the device.

### 3. Electrolysis Cell

An electrolysis cell includes any fluid treatment cell that is adapted to apply an electric field across the fluid between at least one anode electrode and at least one cathode electrode. An electrolysis cell can have any suitable number of electrodes, any suitable number of chambers for containing the fluid, and any suitable number of fluid inputs and fluid outputs. The cell can be adapted to treat any fluid (such as a liquid or gas-liquid combination). The cell can include one or more ion-selective membranes between the anode and cathode or can be configured without any ion selective membranes. An electrolysis cell having an ion-selective membrane is referred to herein as a “functional generator”.

Electrolysis cells can be used in a variety of different applications and can have a variety of different structures, such as but not limited to the structures disclosed in Field et al. U.S. Patent Publication No. 2007/0186368, published Aug. 16, 2007.

### 4. Electrolysis Cell Having a Membrane

### 4.1 Cell Structure

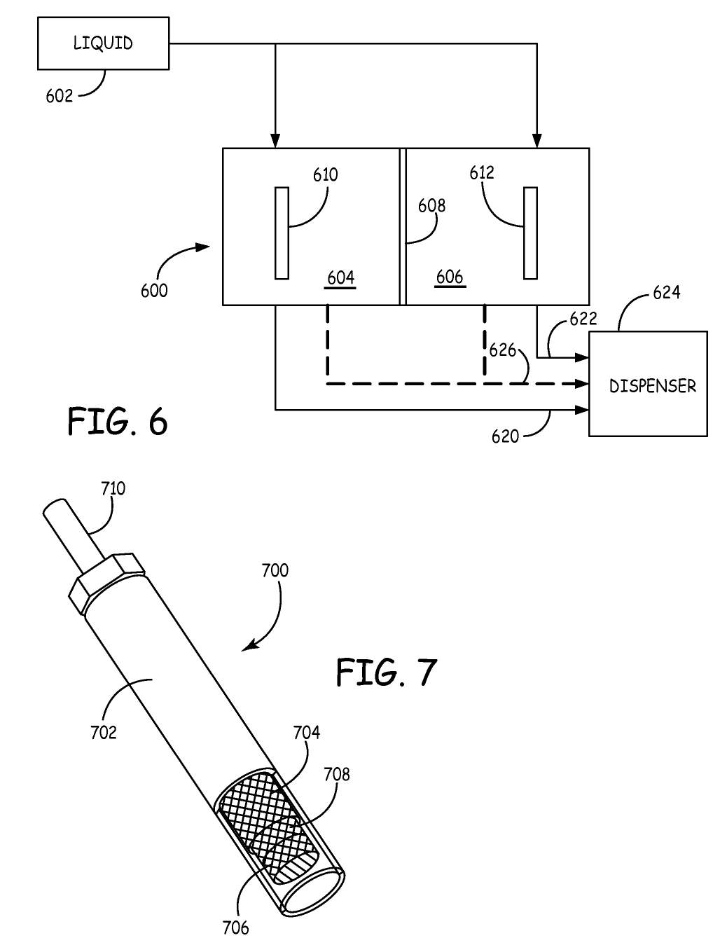

FIG. 6 is a schematic diagram illustrating an example of an electrolysis cell 600 that can be used in the pre-spray and cleaning devices disclosed herein, for example. Electrolysis cell 600 receives liquid to be treated from a liquid source 602. Liquid source 602 can include a tank or other solution reservoir, such as reservoir 202 in FIG. 2, or can include a fitting or other inlet for receiving a liquid from an external source.

Cell 600 has one or more anode chambers 604 and one or more cathode chambers 606 (known as reaction chambers), which are separated by an ion exchange membrane 608, such as a cation or anion exchange membrane. One or more anode electrodes 610 and cathode electrodes 612 (one of each electrode shown) are disposed in each anode chamber 604 and each cathode chamber 606, respectively. The anode and cathode electrodes 610, 612 can be made from any suitable material, such as a conductive polymer, titanium and/or titanium coated with a precious metal, such as platinum, or any other suitable electrode material. The electrodes and respective chambers can have any suitable shape and construction. For example, the electrodes can be flat plates, coaxial plates, rods, or a combination thereof. Each electrode can have, for example, a solid construction or can have one or more apertures. In one example, each electrode is formed as a mesh. In addition, multiple cells 600 can be coupled in series or in parallel with one another, for example.

The electrodes 610, 612 are electrically connected to opposite terminals of a conventional power supply (not shown), such as battery 206 and control circuit 207 in FIG. 2. Ion exchange membrane 608 is located between electrodes 610 and 612. The power supply can provide a constant DC output voltage, a pulsed or otherwise modulated DC output voltage, and/or a pulsed or otherwise modulated AC output voltage to the anode and cathode electrodes. The power supply can have any suitable output voltage level, current level, duty cycle or waveform.

For example in one embodiment, the power supply applies the voltage supplied to the plates at a relative steady state. The power supply (and/or control electronics) includes a DC/DC converter that uses a pulse-width modulation (PWM) control scheme to control voltage and current output. Other types of power supplies can also be used, which can be pulsed or not pulsed and at other voltage and power ranges. The parameters are application-specific.

During operation, feed water (or other liquid to be treated) is supplied from source 602 to both anode chamber 604 and cathode chamber 606. In the case of a cation exchange membrane, upon application of a DC voltage potential across anode 610 and cathode 612, such as a voltage in a range of about 5 Volts (V) to about 25V, cations originally present in the anode chamber 604 move across the ion-exchange membrane 608 towards cathode 612 while anions in anode chamber 604 move towards anode 610. However, anions present in cathode chamber 606 are not able to pass through the cation-exchange membrane, and therefore remain confined within cathode chamber 606.

As a result, cell 500 electrochemically activates the feed water by at least partially utilizing electrolysis and produces electrochemically-activated water in the form of an acidic anolyte composition 620 and a basic catholyte composition 622.

If desired, the anolyte and catholyte can be generated in different ratios to one another through modifications to the structure of the electrolysis cell and/or the voltage patterns applied to the electrodes, for example. For example, the cell can be configured to produce a greater volume of catholyte than anolyte if the primary function of the ECA water is cleaning. Alternatively, for example, the cell can be configured to produce a greater volume of anolyte than catholyte if the primary function of the ECA water is sanitizing. Also, the concentrations of reactive species in each can be varied.

For example, the cell can have a 3:2 ratio of cathode plates to anode plates for producing a greater volume of catholyte than anolyte. Each cathode plate is separated from a respective anode plate by a respective ion exchange membrane. Thus, there are three cathode chambers for two anode chambers. This configuration produces roughly 60% catholyte to 40% anolyte. Other ratios can also be used.

### 4.2 Example Reactions

In addition, water molecules in contact with anode 610 are electrochemically oxidized to oxygen (O₂) and hydrogen ions (H⁺) in the anode chamber 604 while water molecules in contact with the cathode 612 are electrochemically reduced to hydrogen gas (H₂) and hydroxyl ions (OH⁻) in the cathode chamber 606. The hydrogen ions in the anode chamber 604 are allowed to pass through the cation-exchange membrane 608 into the cathode chamber 606 where the hydrogen ions are reduced to hydrogen gas while the oxygen gas in the anode chamber 604 oxygenates the feed water to form the anolyte 620. Furthermore, since regular tap water typically includes sodium chloride and/or other chlorides, the anode 610 oxidizes the chlorides present to form chlorine gas. As a result, a substantial amount of chlorine is produced and the pH of the anolyte composition 620 becomes increasingly acidic over time.

As noted, water molecules in contact with the cathode 612 are electrochemically reduced to hydrogen gas and hydroxyl ions (OH⁻) while cations in the anode chamber 604 pass through the cation-exchange membrane 608 into the cathode chamber 606 when the voltage potential is applied. These cations are available to ionically associate with the hydroxyl ions produced at the cathode 612, while hydrogen gas bubbles form in the liquid. A substantial amount of hydroxyl ions accumulates over time in the cathode chamber 606 and reacts with cations to form basic hydroxides. In addition, the hydroxides remain confined to the cathode chamber 606 since the cation-exchange membrane does not allow the negatively charged hydroxyl ions pass through the cation-exchange membrane. Consequently, a substantial amount of hydroxides is produced in the cathode chamber 606, and the pH of the catholyte composition 7622 becomes increasingly alkaline over time.

The electrolysis process in the functional generator 600 allow concentration of reactive species and the formation of metastable ions and radicals in the anode chamber 604 and cathode chamber 606.

The electrochemical activation process typically occurs by either electron withdrawal (at anode 610) or electron introduction (at cathode 612), which leads to alteration of physiochemical (including structural, energetic and catalytic) properties of the feed water. It is believed that the feed water (anolyte or catholyte) gets activated in the immediate proximity of the electrode surface where the electric field intensity can reach a very high level. This area can be referred to as an electric double layer (EDL).

While the electrochemical activation process continues, the water dipoles generally align with the field, and a proportion of the hydrogen bonds of the water molecules consequentially break. Furthermore, singly-linked hydrogen atoms bind to the metal atoms (e.g., platinum atoms) at cathode electrode 612, and single-linked oxygen atoms bind to the metal atoms (e.g., platinum atoms) at the anode electrode 610. These bound atoms diffuse around in two dimensions on the surfaces of the respective electrodes until they take part in further reactions. Other atoms and polyatomic groups may also bind similarly to the surfaces of anode electrode 610 and cathode electrode 612, and may also subsequently undergo reactions. Molecules such as oxygen (O₂) and hydrogen (H₂) produced at the surfaces may enter small cavities in the liquid phase of the water (i.e., bubbles) as gases and/or may become solvated by the liquid phase of the water. These gas-phase bubbles are thereby dispersed or otherwise suspended throughout the liquid phase of the feed water.

The sizes of the gas-phase bubbles may vary depending on a variety of factors, such as the pressure applied to the feed water, the composition of the salts and other compounds in the feed water, and the extent of the electrochemical activation. Accordingly, the gas-phase bubbles may have a variety of different sizes, including, but not limited to macrobubbles, microbubbles, nanobubbles, and mixtures thereof. In embodiments including macrobubbles, examples of suitable average bubble diameters for the generated bubbles include diameters ranging from about 500 micrometers to about one millimeter. In embodiments including microbubbles, examples of suitable average bubble diameters for the generated bubbles include diameters ranging from about one micrometer to less than about 500 micrometers. In embodiments including nanobubbles, examples of suitable average bubble diameters for the generated bubbles include diameters less than about one micrometer, with particularly suitable average bubble diameters including diameters less than about 500 nanometers, and with even more particularly suitable average bubble diameters including diameters less than about 100 nanometers.

Surface tension at a gas-liquid interface is produced by the attraction between the molecules being directed away from the surfaces of anode electrode 610 and cathode electrode 612 as the surface molecules are more attracted to the molecules within the water than they are to molecules of the gas at the electrode surfaces. In contrast, molecules of the bulk of the water are equally attracted in all directions. Thus, in order to increase the possible interaction energy, surface tension causes the molecules at the electrode surfaces to enter the bulk of the liquid.

In the embodiments in which gas-phase nanobubbles are generated, the gas contained in the nanobubbles (i.e., bubbles having diameters of less than about one micrometer) are also believed to be stable for substantial durations in the feed water, despite their small diameters. While not wishing to be bound by theory, it is believed that the surface tension of the water, at the gas/liquid interface, drops when curved surfaces of the gas bubbles approach molecular dimensions. This reduces the natural tendency of the nanobubbles to dissipate.

Furthermore, nanobubble gas/liquid interface is charged due to the voltage potential applied across membrane 608. The charge introduces an opposing force to the surface tension, which also slows or prevents the dissipation of the nanobubbles. The presence of like charges at the interface reduces the apparent surface tension, with charge repulsion acting in the opposite direction to surface minimization due to surface tension. Any effect may be increased by the presence of additional charged materials that favor the gas/liquid interface.

The natural state of the gas/liquid interfaces appears to be negative. Other ions with low surface charge density and/or high polarizability (such as Cl⁻, ClO⁻, HO₂⁻, and O₂⁻) also favor the gas/liquid interfaces, as do hydrated electrons. Aqueous radicals also prefer to reside at such interfaces. Thus, it is believed that the nanobubbles present in the catholyte (i.e., the water flowing through cathode chamber 56) are negatively charged, but those in the anolyte (i.e., the water flowing through anode chamber 54) will possess little charge (the excess cations cancelling out the natural negative charge). Accordingly, catholyte nanobubbles are not likely to lose their charge on mixing with the anolyte.

Additionally, gas molecules may become charged within the nanobubbles (such as O₂⁻), due to the excess potential on the cathode, thereby increasing the overall charge of the nanobubbles. The surface tension at the gas/liquid interface of charged nanobubbles can be reduced relative to uncharged nanobubbles, and their sizes stabilized. This can be qualitatively appreciated as surface tension causes surfaces to be minimized, whereas charged surfaces tend to expand to minimize repulsions between similar charges. Raised temperature at the electrode surface, due to the excess power loss over that required for the electrolysis, may also increase nanobubble formation by reducing local gas solubility.

As the repulsion force between like charges increases inversely as the square of their distances apart, there is an increasing outwards pressure as a bubble diameter decreases. The effect of the charges is to reduce the effect of the surface tension, and the surface tension tends to reduce the surface whereas the surface charge tends to expand it. Thus, equilibrium is reached when these opposing forces are equal. For example, assuming the surface charge density on the inner surface of a gas bubble (radius r) is Φ(e⁻/meter²), the outwards pressure (“Pₒᵤₜ”), can be found by solving the NavierStokes equations to give:

Pₒᵤₜ=Φ²/2D∈₀ (Equation 1)

where D is the relative dielectric constant of the gas bubble (assumed unity), “∈₀” is the permittivity of a vacuum (i.e., 8.854 pF/meter). The inwards pressure (“Pᵢₙ”) due to the surface tension on the gas is:

Pᵢₙ=2g/r Pₒᵤₜ (Equation 2)

where “g” is the surface tension (0.07198 Joules/meter² at 25° C.). Therefore if these pressures are equal, the radius of the gas bubble is:

r=0.28792 ∈₀/Φ². (Equation 3)

Accordingly, for nanobubble diameters of 5 nanometers, 10 nanometers, 20 nanometers, 50 nanometers, and 100 nanometers the calculated charge density for zero excess internal pressure is 0.20, 0.14, 0.10, 0.06 and 0.04 e⁻/nanometer bubble surface area, respectively. Such charge densities are readily achievable with the use of an electrolysis cell (e.g., electrolysis cell 600). The nanobubble radius increases as the total charge on the bubble increases to the power ⅔. Under these circumstances at equilibrium, the effective surface tension of the fuel at the nanobubble surface is zero, and the presence of charged gas in the bubble increases the size of the stable nanobubble. Further reduction in the bubble size would not be indicated as it would cause the reduction of the internal pressure to fall below atmospheric pressure.

In various situations within the electrolysis cell (e.g., electrolysis cell 600), the nanobubbles may divide into even smaller bubbles due to the surface charges. For example, assuming that a bubble of radius “r” and total charge “q” divides into two bubbles of shared volume and charge (radius r½=r/2^{1/3}, and charge q_{1/2}=q/2), and ignoring the Coulomb interaction between the bubbles, calculation of the change in energy due to surface tension (ΔE_{ST}) and surface charge (ΔE_{q}) gives:

$$\begin{matrix}Δ {E}_{ST} = + 2 ( 4 π γ {r}_{1 / 2}^{2} ) - 4 π γ {r}^{2} = 4 π {γ}^{2} ( {2}^{1 / 3} - 1 ) \\ and & ( Equation 3 ) \\ Δ {E}_{q} = - 2 ( \frac{1}{2} \times \frac{{( q / 2 )}^{2}}{4 π {ɛ}_{0} {ɛ}_{1 / 2}} ) - \frac{1}{2} \times \frac{{q}^{2}}{4 π {ɛ}_{0} r} \\ = \frac{{q}^{2}}{8 π {ɛ}_{0} r} ( 1 - {2}^{- 2 / 3} ) & ( Equation 4 )\end{matrix}$$

The bubble is metastable if the overall energy change is negative which occurs when ΔE_{ST}+ΔE_{q} is negative, thereby providing:

$$\frac{{q}^{2}}{8 π {ɛ}_{0} r} ( 1 - {2}^{- 2 / 3} ) + 4 π γ {r}^{2} ( {2}^{1 / 3} - 1 ) \leq 0 \qquad ( Equation 5 )$$

which provides the relationship between the radius and the charge density (Φ):

$$φ = \frac{q}{4 π {r}^{2}} \geq \sqrt{( \frac{2 γ {ɛ}_{q}}{r} \frac{( {2}^{1 / 3} - 1 )}{( 1 - {2}^{- 2 / 3} )} )} \qquad ( Equation 6 )$$

Accordingly, for nanobubble diameters of 5 nanometers, 10 nanometers, 20 nanometers, 50 nanometers, and 100 nanometers the calculated charge density for bubble splitting 0.12, 0.08, 0.06, 0.04 and 0.03 e⁻/nanometer² bubble surface area, respectively. For the same surface charge density, the bubble diameter is typically about three times larger for reducing the apparent surface tension to zero than for splitting the bubble in two. Thus, the nanobubbles will generally not divide unless there is a further energy input.

The above-discussed gas-phase nanobubbles are adapted to attach to dirt particles, thereby transferring their ionic charges. The nanobubbles stick to hydrophobic surfaces, which are typically found on typical dirt particles, which releases water molecules from the high energy water/hydrophobic surface interface with a favorable negative free energy change. Additionally, the nanobubbles spread out and flatten on contact with the hydrophobic surface, thereby reducing the curvatures of the nanobubbles with consequential lowering of the internal pressure caused by the surface tension. This provides additional favorable free energy release. The charged and coated dirt particles are then more easily separated one from another due to repulsion between similar charges, and the dirt particles enter the solution as colloidal particles.

Furthermore, the presence of nanobubbles on the surface of particles increases the pickup of the particle by micron-sized gas-phase bubbles, which may also be generated during the electrochemical activation process. The presence of surface nanobubbles also reduces the size of the dirt particle that can be picked up by this action. Such pickup assist in the removal of the dirt particles from floor surfaces and prevents re-deposition. Moreover, due to the large gas/liquid surface area-to-volume ratios that are attained with gas-phase nanobubbles, water molecules located at this interface are held by fewer hydrogen bonds, as recognized by water's high surface tension. Due to this reduction in hydrogen bonding to other water molecules, this interface water is more reactive than normal water and will hydrogen bond to other molecules more rapidly, thereby showing faster hydration.

For example, at 100% efficiency a current of one ampere is sufficient to produce 0.5/96,485.3 moles of hydrogen (H₂) per second, which equates to 5.18 micromoles of hydrogen per second, which correspondingly equates to 5.18×22.429 microliters of gas-phase hydrogen per second at a temperature of 0° C. and a pressure of one atmosphere. This also equates to 125 microliters of gas-phase hydrogen per second at a temperature of 20° C. and a pressure of one atmosphere. As the partial pressure of hydrogen in the atmosphere is effectively zero, the equilibrium solubility of hydrogen in the electrolyzed solution is also effectively zero and the hydrogen is held in gas cavities (e.g., macrobubbles, microbubbles, and/or nanobubbles).

Assuming the flow rate of the electrolyzed solution is 0.12 U.S. gallons per minute, there is 7.571 milliliters of water flowing through the electrolysis cell each second. Therefore, there are 0.125/7.571 liters of gas-phase hydrogen within the bubbles contained in each liter of electrolyzed solution at a temperature of 20° C. and a pressure of one atmosphere. This equates to 0.0165 liters of gas-phase hydrogen per liter of solution less any of gas-phase hydrogen that escapes from the liquid surface and any that dissolves to supersaturate the solution.

The volume of a 10 nanometer-diameter nanobubble is 5.24×10⁻²² liters, which, on binding to a hydrophobic surface covers about 1.25×10⁻¹⁶ square meters. Thus, in each liter of solution there would be a maximum of about 3×10⁻¹⁹ bubbles (at 20° C. and one atmosphere) with combined surface covering potential of about 4000 square meters. Assuming a surface layer just one molecule thick, this provides a concentration of active surface water molecules of over 50 millimoles. While this concentration represents a maximum amount, even if the nanobubbles have greater volume and greater internal pressure, the potential for surface covering remains large. Furthermore, only a small percentage of the dirt particles surfaces need to be covered by the nanobubbles for the nanobubbles to have a cleaning effect.

Accordingly, the gas-phase nanobubbles, generated during the electrochemical activation process, are beneficial for attaching to dirt particles so transferring their charge. The resulting charged and coated dirt particles are more readily separated one from another due to the repulsion between their similar charges. They will enter the solution to form a colloidal suspension. Furthermore, the charges at the gas/water interfaces oppose the surface tension, thereby reducing its effect and the consequent contact angles. Also, the nanobubbles coating of the dirt particles promotes the pickup of larger buoyant gas-phase macrobubbles and microbubbles that are introduced. In addition, the large surface area of the nanobubbles provides significant amounts of higher reactive water, which is capable of the more rapid hydration of suitable molecules.

### 5. Ion Exchange Membrane

As mentioned above, the ion exchange membrane 608 can include a cation exchange membrane (i.e., a proton exchange membrane) or an anion exchange membrane. Suitable cation exchange membranes for membrane 608 include partially and fully fluorinated ionomers, polyaromatic ionomers, and combinations thereof. Examples of suitable commercially available ionomers for membrane 38 include sulfonated tetrafluorethylene copolymers available under the trademark “NAFION” from E.I. du Pont de Nemours and Company, Wilmington, Del.; perfluorinated carboxylic acid ionomers available under the trademark “FLEMION” from Asahi Glass Co., Ltd., Japan; perfluorinated sulfonic acid ionomers available under the trademark “ACIPLEX” Aciplex from Asahi Chemical Industries Co. Ltd., Japan; and combinations thereof. However, any ion exchange membrane can be used in other examples.

### 6. Dispenser

The acidic anolyte and basic catholyte ECA liquid outputs can be coupled to a dispenser 624 of the pre-spray device, which can include any type of dispenser or dispensers, such as an outlet, fitting, spigot, spray head, a cleaning/sanitizing tool or head, etc. In the example shown in FIG. 2, dispenser 624 includes spray nozzle 210. There can be a dispenser for each output 620 and 622 or a combined dispenser for both outputs.

In one example, the anolyte and catholyte outputs are blended into a common output stream 626, which is supplied to dispenser 624. As described in Field et al. U.S. Patent Publication No. 2007/0186368, it has been found that the anolyte and catholyte can be blended together within the distribution system of a cleaning apparatus and/or on the surface or item being cleaned while at least temporarily retaining beneficial cleaning and/or sanitizing properties. Although the anolyte and catholyte are blended, they are initially not in equilibrium and therefore temporarily retain their enhanced cleaning and/or sanitizing properties.

For example, in one embodiment, the catholyte ECA water and the anolyte ECA water maintain their distinct electrochemically activated properties for at least 30 seconds, for example, even though the two liquids are blended together. During this time, the distinct electrochemically activated properties of the two types of liquids do not neutralize immediately. This allows the advantageous properties of each liquid to be utilized during a common cleaning operation. After a relatively short period of time, the blended anolyte and catholyte ECA liquid on the surface being cleaned quickly neutralize substantially to the original pH and ORP of the source liquid (e.g., those of normal tap water). In one example, the blended anolyte and catholyte ECA liquid neutralize substantially to a pH between pH6 and pH8 and an ORP between ±50 mV within a time window of less than 1 minute from the time the anolyte and catholyte ECA outputs are produced by the electrolysis cell. Thereafter, the recovered liquid can be disposed in any suitable manner.

However, in other embodiments, the blended anolyte and catholyte ECA liquid can maintain pHs outside of the range between pH6 and pH8 and ORPs outside the range of ±50 mV for a time greater than 30 seconds, and/or can neutralize after a time range that is outside of 1 minute, depending on the properties of the liquid.

In a further example, The acidic anolyte and basic catholyte ECA liquid outputs 620 and 622 are supplied to separate dispensers 624 (such as two spray nozzles) and applied concurrently to the surface as a combined pre-spray.

### 7. Tubular Electrode Example

The electrodes themselves can have any suitable shape, such as planar, coaxial plates, cylindrical rods, or a combination thereof. FIG. 7 illustrates an example of an electrolysis cell 700 having a tubular shape according to one illustrative example. Portions of cell 700 are cut away for illustration purposes. In this example, cell 700 is an electrolysis cell having a tubular housing 702, a tubular outer electrode 704, and a tubular inner electrode 706, which is separated from the outer electrode by a suitable gap, such as 0.020 inches. Other gap sizes can also be used. An ion-selective membrane 708 is positioned between the outer and inner electrodes 704 and 706. In one example, outer electrode 704 and inner electrode 706 have conductive polymer constructions with apertures. However, one or both electrodes can have a solid construction in another example.

In this example, the volume of space within the interior of tubular electrode 706 is blocked to promote liquid flow along and between electrodes 704 and 706 and ion-selective membrane 708. This liquid flow is conductive and completes an electrical circuit between the two electrodes. Electrolysis cell 700 can have any suitable dimensions. In one example, cell 700 can have a length of about 4 inches long and an outer diameter of about ¾ inch. The length and diameter can be selected to control the treatment time and the quantity of bubbles, e.g., nanobubbles and/or microbubbles, generated per unit volume of the liquid.

Cell 700 can include a suitable fitting at one or both ends of the cell. Any method of attachment can be used, such as through plastic quick-connect fittings. For example, one fitting can be configured to connect to the output tube of pump 204 shown in FIG. 2. Another fitting can be configured to connect to tubing 710 that supplies wand 212 in FIG. 2, for example.

In the example shown in FIG. 7, cell 700 produces anolyte ECA liquid in the anode chamber (between one of the electrodes 704 or 706 and ion-selective membrane 708) and catholyte ECA liquid in the cathode chamber (between the other of the electrodes 704 or 706 and ion-selective membrane 708). The anolyte and catholyte ECA liquid flow paths join at the outlet of cell 700 as the anolyte and catholyte ECA liquids enter tube 710. As a result, the pre-spray device dispenses a blended anolyte and catholyte EA liquid through nozzle 210 (in the example shown in FIG. 2).

With the tubular cell structure shown in FIG. 7, the electrolysis cell can easily be implemented in the flow path within wand 212, if desired, or at any other location.

Another example of a suitable electrolysis cell includes the Emco Tech “JP102” cell found within the JP2000 ALKABLUE LX, which is available from Emco Tech Co., LTD, of Yeupdong, Goyang-City, Kyungki-Do, South Korea. This particular cell has a DC range of 27 Volts, a pH range of about 10 to about 5.0, a cell size of 62 mm by 109 mm by 0.5 mm, and five electrode plates. Other types of electrolysis cells can also be used, which can have various different specifications.

### 8. Control Circuit

Referring back to FIG. 2, control circuit 207 can include any suitable control circuit, which can be implemented in hardware, software, or a combination of both, for example.

Control circuit 207 includes a printed circuit board containing electronic devices for powering and controlling the operation of pump 204 and electrolysis cell 208. In one example, control circuit 207 includes a power supply having an output that is coupled to pump 204 and electrolysis cell 208 and which controls the power delivered to the two devices. Control circuit 207 also includes an H-bridge, for example, that is capable of selectively reversing the polarity of the voltage applied to electrolysis cell 208 as a function of a control signal generated by the control circuit. For example, control circuit 207 can be configured to alternate polarity in a predetermined pattern, such as every 5 seconds (or e.g., 15 seconds, 150 seconds, etc.) with a 50% duty cycle. In another example, control circuit 207 is configured to apply a voltage to the cell with primarily a first polarity and periodically reverse the polarity for only very brief periods of time. Frequent reversals of polarity can provide a self-cleaning function to the electrodes, which can reduce scaling or build-up of deposits on the electrode surfaces and can extend the life of the electrodes.

In the context of a hand-held pre-spray device, it is inconvenient to carry large batteries. Therefore, the available power to the pump and cell is somewhat limited. In one example, the driving voltage for the cell is in the range of about 18 Volts to about 24 Volts. But since typical flow rates through the device may be fairly low, only relatively small currents are necessary to effectively activate the liquid passing through the cell. With low flow rates, the residence time within the cell is relatively large. The longer the liquid resides in the cell while the cell is energized, the greater the electrochemical activation (within practical limits). This allows the pre-spray device to employ smaller capacity batteries and a DC-to-DC converter, which steps the voltage up to the desired output voltage at a low current.

For example, the pre-spray device can carry one or more batteries having an output voltage of about 3-9 Volts. For example, the pre-spray device can carry four AA batteries, each having a nominal output voltage of 1.5 Volts at about 500 milliampere-hours to about 3 ampere-hours. If the batteries are connected in series, then the nominal output voltage would be about 6V with a capacity of about 500 milliampere-hours to about 3 ampere-hours. This voltage can be stepped up to the range of 18 Volts to 24 Volts, for example, through the DC-to-DC converter. Thus, the desired electrode voltage can be achieved at a sufficient current. An example of a suitable DC-to-DC converter is the Series A/SM surface mount converter from PICO Electronics, Inc. of Pelham, N.Y.

### 9. Driving Voltage for Electrolysis Cell

As described above, the electrodes of the electrolysis cell can be driven with a variety of different voltage and current patterns, depending on the particular application of the cell. It is desirable to limit scaling on the electrodes by periodically reversing the voltage polarity that is applied to the electrodes. Therefore, the terms “anode” and “cathode” and the terms “anolyte” and “catholyte” as used in the description and claims are respectively interchangeable. This tends to repel oppositely-charged scaling deposits.

In one example, the electrodes are driven at one polarity for a specified period of time (e.g., about 5 seconds or 15 seconds) and then driven at the reverse polarity for approximately the same period of time. Since the anolyte and cathotlyte EA liquids are blended at the outlet of the cell, this process produces essentially one part anolyte EA liquid to one part catholyte EA liquid.

In another example, the electrolysis cell is controlled to produce a substantially constant anolyte EA liquid or catholyte EA liquid from each chamber without complicated valving. In prior art electrolysis systems, complicated and expensive valving is used to maintain constant anolyte and catholyte through respective outlets while still allowing the polarity to be reversed to minimize scaling. For example, looking at FIG. 6, when the polarity of the voltage applied to the electrodes is reversed, the anode becomes a cathode, and the cathode becomes an anode. The outlet 620 will deliver catholyte instead of anolyte, and outlet 622 will deliver anolyte instead of catholyte.

Although the present disclosure has been described with reference to one or more examples, workers skilled in the art will recognize that changes may be made in form and detail without departing from the scope of the disclosure and/or the appended claims.

What is claimed is:

1. A method comprising:
applying electrochemically activated acid and alkaline water to a surface as a pre-spray;
allowing the electrochemically activated acid and alkaline water to remain on the surface for a dwell time; and
after the dwell time, performing a cleaning operation on an area of the surface to which the pre-spray was applied.

2. The method of claim 1, wherein the dwell time is at least one minute.

3. The method of claim 1, wherein the dwell time is at least five minutes.

4. The method of claim 1, wherein the dwell time is in a range of one minute to one-half an hour.

5. The method of claim 1, wherein the surface comprises carpet.

6. The method of claim 1, wherein:
the step of applying is performed by a pre-spray device; and
the cleaning operation is performed by a cleaning device that is disconnected from the pre-spray device and separately movable relative to the surface.

7. The method of claim 6, wherein the step of applying is performed by a pre-spray device that is a member of the group comprising:
a hand-held spray bottle comprising an electrolysis cell,
a humanly portable, non-wheeled canister comprising an electrolysis cell and a spray wand;
a wheeled device carrying an electrolysis cell and a ECA water dispenser.

8. The method of claim 1, wherein the step of applying comprises generating the electrochemically activated acid and alkaline water with an electrolysis cell carried by a pre-spray device, blending the electrochemically activated acid and alkaline water within the pre-spray device and applying the blended electrochemically activated acid and alkaline water to the surface as the pre-spray with the pre-spray device.

9. The method of claim 1 wherein the step of performing a cleaning operation is performed by a cleaning device that is a member of the group comprising:
a hot water extractor; and
a soil transfer device comprising a soil transfer roller.

10. The method of claim 1, wherein the step of applying is performed in a first pass over the surface with a wheeled device and the step of performing a cleaning operation is performed in a second, subsequent pass over the surface with the same wheeled device.

11. The method of claim 1, wherein the step of performing a cleaning operation comprises applying further electrochemically activated water to the surface with a wheeled, mobile cleaning device and then recovering, with the mobile cleaning device, at least portions of the electrochemically activated water that was applied as the pre-spray and at least portions of the further electrochemically activated water applied by the mobile cleaning device.

12. A method comprising:
applying electrochemically activated acid and alkaline water to carpet as a combined pre-spray with a pre-spray device;
allowing the electrochemically activated water to remain on the carpet for a dwell time; and
after the dwell time, recovering the electrochemically activated water from the carpet during a cleaning operation performed with a cleaning device, which is unconnected to the pre-spray device and separately movable relative to the carpet.

13. The method of claim 12, wherein the dwell time is at least one minute.

14. The method of claim 12, wherein the dwell time is at least five minutes.

15. The method of claim 12, wherein the dwell time is in a range of one minute to one-half an hour.

16. The method of claim 12, wherein the pre-spray device is a member of the group comprising:
a hand-held spray bottle comprising an electrolysis cell,
a humanly portable, non-wheeled canister comprising an electrolysis cell and a spray wand;
a wheeled device carrying an electrolysis cell and a ECA water dispenser.

17. The method of claim 12, wherein the step of applying comprises generating the electrochemically activated acid and alkaline water with an electrolysis cell carried by the pre-spray device, blending the electrochemically activated acid and alkaline water within the pre-spray device and applying the blended electrochemically activated acid and alkaline water to the surface as the combined pre-spray with the pre-spray device.

18. The method of claim 12, wherein the step of applying comprises generating the electrochemically activated acid and alkaline water with an electrolysis cell carried by the pre-spray device, combining separate flows of the acid and alkaline water into a combined flow applying the combined flow to the surface through a spray nozzle.

19. The method of claim 12 wherein the cleaning device is a member of the group comprising:
a hot water extractor; and
a soil transfer device comprising a soil transfer roller.

20. The method of claim 12, wherein:
the cleaning device comprises a wheeled mobile cleaning device;
the step of performing a cleaning operation comprises applying further electrochemically activated water to the surface with the wheeled mobile cleaning device; and
recovering, with the wheeled mobile cleaning device, at least portions of the electrochemically activated water that was applied as the pre-spray and at least portions of the further electrochemically activated water applied by the wheeled mobile cleaning device.
